(19) United States
(12) Patent Application Publication
(10) Pub. No.: US 2004/0155757 A1
(43) Pub. Date: Aug. 12, 2004

(54) Apparatus and method for monitoring security camera operation over a powerline network

(76) Inventors: Louis Robert Litwin JR., Plainsboro, NJ (US); John William Richardson, Hamilton, NJ (US); Kumar Ramaswamy, Princeton, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/364,134

(22) Filed: Feb. 11, 2003

(51) Int. Cl. H04M 11/04

(52) U.S. Cl. 340/310.01

(57) ABSTRACT

An apparatus for monitoring operation of a security camera on a powerline network includes a powerline modem for coupling to a powerline network for receiving a monitoring signal from a security camera coupled to said powerline network, and a computer configured for processing said monitoring signal, determining a status of said security camera based on said processing and generating a response notifying said status based on said determining.

### BACKGROUND

1. Technical Field

This disclosure relates to powerline modem networks and, more particularly to monitoring a security camera over a powerline modem network.

2. Description of the Related Art Powerline modems are communication devices that are able to communicate over the electrical power distribution network in a home or office. These modems enable multiple devices to communicate with one another by using the power network as a transmission medium. For example, a computer equipped with a powerline modem can send/receive data from a similarly-equipped home appliance such as a stereo. The bandwidth of such a system is high enough to allow the transmission of compressed digital video and audio as well as other forms of data.

A properly configured security camera can communicate over a powerline network. In an analog network the video is always transmitted so the loss of the signal would indicate a problem with the security camera. In a digital packet-based powerline modem network, the transmission of video is not necessarily continuous. Consequently, detecting non-existence of a digital signal from the security camera would not necessarily indicate an operational problem with the security camera.

Accordingly, there is a need for monitoring operation of security cameras on a powerline network.

### SUMMARY OF THE INVENTION

An apparatus for monitoring operation of a security camera on a powerline network includes a powerline modem for coupling to a powerline network for receiving a monitoring signal from a security camera coupled to said powerline network, and a computer configured for processing said monitoring signal, determining a status of said security camera based on said processing and generating a response notifying said status based on said determining.

A method for monitoring status of a security camera for transmitting video information over a powerline network, including the steps of detecting a signal from a security camera over a powerline network at predetermined intervals, determining that said security camera is properly operating when said signal is detected, awaiting to detect another said signal if said signal is detected, and determining an operational problem exists with said security camera if said signal is not detected.

A computer readable medium containing software instructions that, when executed by a processor, performs the steps of detecting a signal from a security camera over a powerline network, determining an operational status of said security camera based on said step of detecting, awaiting to detect another said signal if said signal is detected, and generating an alert if said signal is not detected.

These and other objects, features and advantages of the present invention will become apparent from the following detailed description of illustrative embodiments thereof, which is to be read in connection with the accompanying drawings.

### BRIEF DESCRIPTION OF DRAWINGS

This disclosure will present in detail the following description of preferred embodiments with reference to the following figures wherein:

FIG. 1 is a block diagram showing an exemplary powerline modem network with multiple devices interconnected over the powerline network;

FIG. 2 is a diagram of a powerline modem network with multiple security cameras and a master device for monitoring operation with a security camera in accordance with an embodiment of the present invention;

FIG. 3 is a block diagram of a process for monitoring security camera operation on a powerline network; and

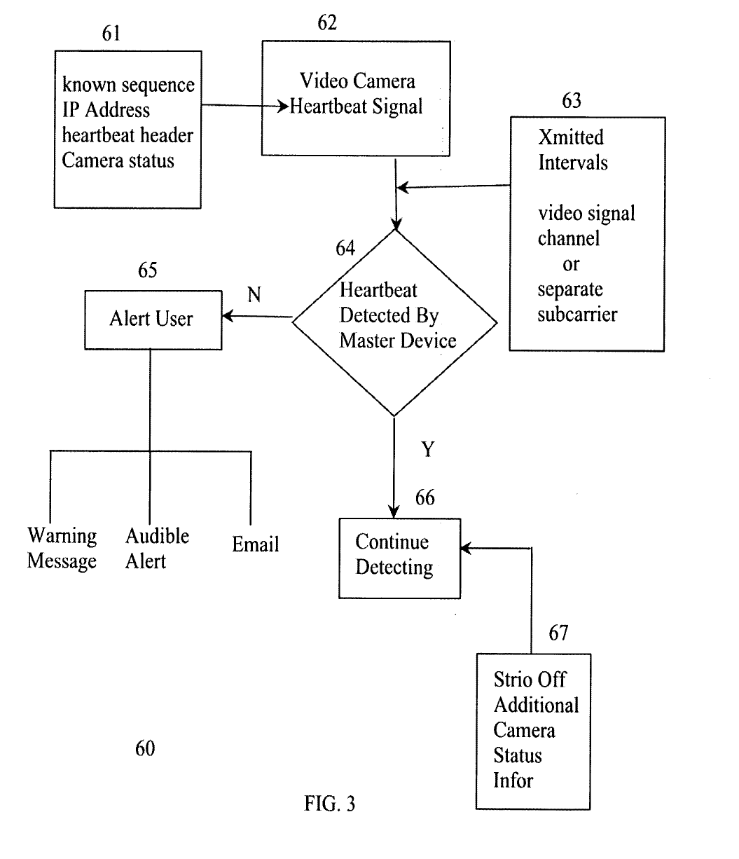

FIG. 4 is a diagram of an exemplary device for monitoring operation of security cameras in accordance with an embodiment of the present invention.

### DETAILED DESCRIPTION OF PREFERRED EMBODIMENTS

This invention is for use with a security camera that operates on a digital powerline modem network. The camera records its video and sends the video signal, via a powerline modem network, to a master device, such as a personal computer (PC). In order to inform the master device that the camera is functioning, a “heartbeat” signal can be periodically sent from each camera. If the master device fails to detect the heartbeat, it can alert the user, as this can indicate either a malfunctioning camera or an intruder tampering with the camera.

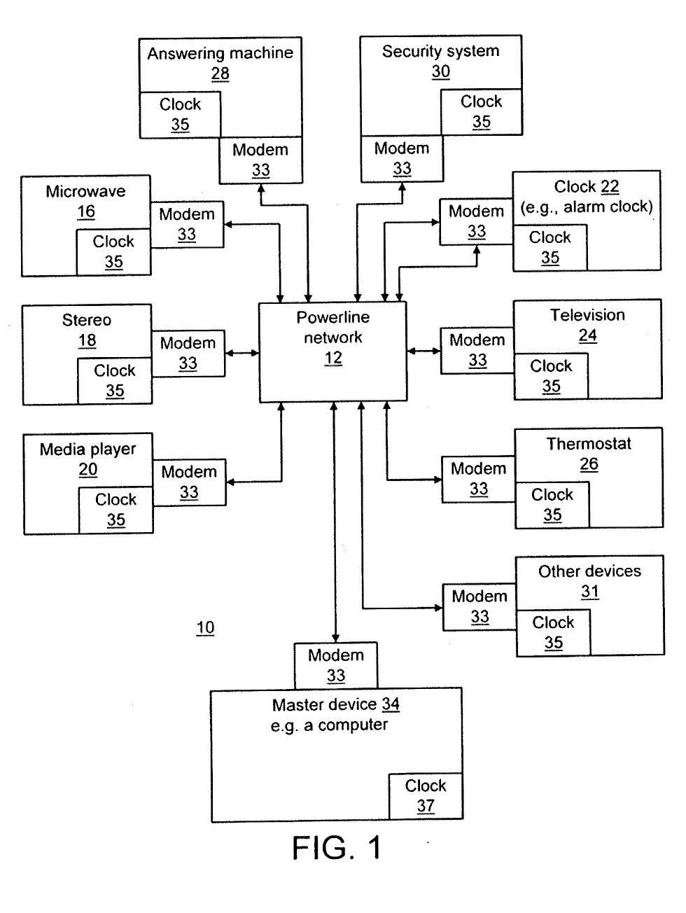

Referring now in specific detail to the drawings in which like reference numerals identify similar or identical elements throughout the several views, and initially to FIG. 1, a block diagram of an illustrative network 10 is shown in accordance with the present invention. A powerline network 12, which may include a hardwired electrical power system for a home or building, is connected to each of a plurality of devices. These devices may include a microwave 16, a stereo 18, a VCR/DVD or other media player 20, an alarm clock 22, a television 24, a programmable thermostat 26, an answering machine 28, an alarm or security system 30, or any other clock devices 31 which plug into the electrical power system. This list is not exhaustive and other devices are contemplated by the present invention. Each device includes a powerline modem 33, which permits communication between these devices themselves and/or a master device 34. Powerline modems 33 preferably include an embedded processor. The processor of powerline modem 33 can run software whose functions include, but are not limited to, data modulation/demodulation as well as upper-layer network functions such as packet processing. Optionally, each device can include a clock 35 which may be subjected to clock drift or time loss during a power failure.

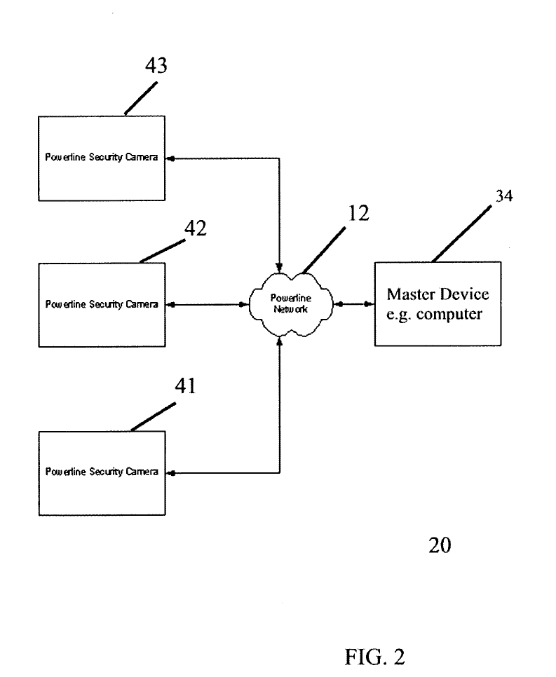

Referring now to FIG. 2, there is shown a diagram 20 of security cameras 41-43 connected to the master device 34 over a powerline network 12. The cameras 41-43 will record video, and possibly audio, and send the recorded video over the powerline network 12 where other powerline modem devices can receive and display the video if needed. An apparatus for receiving the video from a security camera 41-43 can be a set top box (STB) with a powerline modem and a television tuner (not shown). The set top box can decode the video that comes over the powerline network 12 from the security camera 41-43. Hardware and software with the security system 30, security cameras 41-43 or set top box can be configured to detect intrusive motion meeting a security breach condition and control the television to display what is being viewed by the security camera 41-43 in real time. If a security breach or any activity is detected by the security system 30 or the security camera 41-43, the set top box can employ the on board television frequency tuner to send video from the security camera to the television for display.

It is important for the master device 34 on a powerline security camera network to know the status of all cameras. The network is packet-based and the rate of transmission of the video can vary. For instance, if there is a lot of activity in the scene, that camera might transmit video at a rapid rate. However, if there is little or no activity in the scene, a camera might conserve network bandwidth by transmitting video at a very low rate or perhaps not even transmitting at all until there is new activity. Thus, the master device 34 cannot tell if a camera is active or operating properly based on the reception of video from the camera because the camera's transmission can be sporadic. Hence the transmission of a heartbeat signal 62 at known intervals can be employed to inform the master device that the camera is still operational and that it hasn't malfunctioned or been tampered with.

In a packet-based digital powerline modem network, the security cameras can monitor activities and send video back to the master device over the powerline network. Although such technology already exists for an analog powerline modem network, an all-digital solution does not yet exist and it presents some problems. For instance, in a packetbased network, the video from a given camera does not need to be transmitted continuously. If there is a lot of activity in a scene, the camera can transmit video frames at a rapid rate. However, if there is little to no activity, the camera might transmit video frames at a very low rate. Another alternative is that the camera might not even transmit any new frames at all unless there is some change in the scene. The purpose of this approach would be to conserve the scarce powerline network bandwidth by only transmitting video if there is useful information to convey, such as a scene change. However, this means that the transmission of video from a camera will be sporadic, and the reception of that video by the master device 34 cannot be used as an indication of the status of the camera.

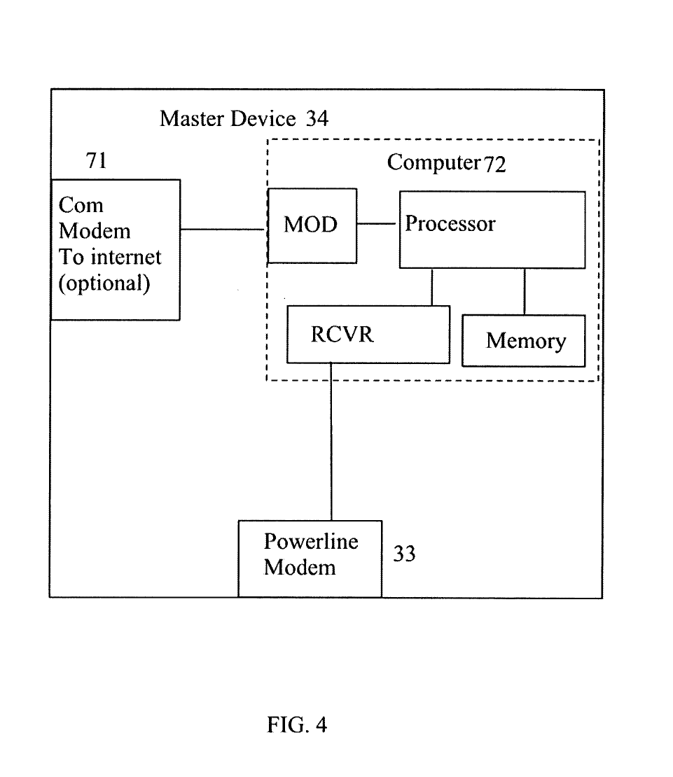

A solution to the problem of possible infrequent video transmissions is to have each video camera send out a “heartbeat”signal 62 to the master device. An exemplary master device 34 depicted in FIG. 4 can include a computer 72 (with processor, receiver RCVR, memory, modulator MOD and a telephone or wireless communications modem Com Modem). This heartbeat signal will be some signal that is transmitted at known intervals 63. The heartbeat does not necessarily need to contain any information, for example, it can just be a known fixed sequence. Reception of the heartbeat signal by the master device 64 can indicate that the particular camera is functioning properly. If the master device fails to detect a heartbeat signal at its scheduled times, it will assume there is a problem with the given camera and it will alert the user 65. The user can be alerted with an audible alert, a text message on the screen, or by an email to the user at a possibly remote location. Some reasons for a camera not transmitting the heartbeat could be a malfunction in the device or malicious tampering with the device by an intruder.

The heartbeat signal preferably should be short in order to avoid wasting precious network bandwidth. The heartbeat signal can be sent over the same communications channel as the video signal 63. The video signal can be compressed digital video and audio signals. Alternatively, a separate sub-carrier can be used to carry the heartbeat signal 63. Many powerline modems use multi-carrier modulation and the heartbeat can be carried on separate sub-carrier(s) rather than on the video signal to avoid disrupting the video stream.

The primary information that the heartbeat signal can carry is the address (e.g., internet protocol IP address) of the camera and a header indicating that it is a heartbeat packet 61. It is also possible for the heartbeat signal to carry camera status information that the master device 34 can strip off as it continues detecting the heartbeat signal 67.

Having described preferred embodiments for monitoring operation of security cameras transmitting over a powerline modem network (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. An apparatus for monitoring operation of a security camera on a powerline network comprising:
a powerline modem for coupling to a powerline network for receiving a monitoring signal from a security camera coupled to said powerline network; and
a computer configured for processing said monitoring signal, determining a status of said security camera based on said processing and generating a response notifying said status based on said determining.

2. The apparatus as recited in claim 1, further comprising a communications modem for coupling to an external network.

3. The apparatus as recited in claim 1, wherein said monitoring signal is a signal sent by said security camera at intervals and an absence of said signal is indicative of said security camera failing to operate properly.

4. The apparatus as recited in claim 1, wherein said monitoring signal comprises an address identifying said camera.

5. The apparatus as recited in claim 1, wherein said monitoring signal comprises status information for said security camera.

6. The apparatus as recited in claim 1, wherein said response is one of a warning message, an audible alert and an email to a remote user.

7. The apparatus according to claim 1, wherein said monitoring signal is included on a carrier with a video signal from said security camera.

8. The apparatus as recited in claim 7, wherein said video signal comprises compressed digital video and audio signals.

9. The apparatus as recited in claim 1, wherein said monitoring signal is transmitted over said powerline network on a sub-carrier channel separate from that of a video signal from said security camera.

10. The apparatus as recited in claim 9, wherein said video signal comprises compressed digital video and audio signals.

11. A method for monitoring status of a security camera for transmitting video information over a powerline network, comprising the steps of:
detecting a signal from a security camera over a powerline network at predetermined intervals;
determining that said security camera is properly operating when said signal is detected;
awaiting to detect another said signal if said signal is detected; and
determining an operational status with said security camera if said signal is not detected.

12. The method according to claim 11, wherein said operational status comprises an operation problem with said security camera.

13. The method according to claim 11, further comprising the step of extracting status information about said security camera from said signal.

14. The method according to claim 11, further comprising the step of alerting a user that said signal is not detected when said step of determining an operational problem with said security camera.

15. The method according to claim 11, wherein said signal is transmitted by said security camera at predetermined intervals.

16. The method according to claim 11, wherein said signal comprises information about said security camera indicative of proper operation of said security camera.

17. The method according to claim 11, wherein said signal is sent by said video camera on a channel carrying video information from said security camera.

18. The method according to claim 17, wherein said video information comprises compressed digital video and audio signals.

19. The method according to claim 11, wherein said signal is sent on a carrier separate from that having video information from said security camera.

20. The method according to claim 19, wherein said video information comprises compressed digital video and audio signals.

21. The method according to claim 9, wherein said signal comprises a packet that includes a network address for said security camera and a header indicating that said signal is an operational status signal for said security camera.

22. The method according to claim 16, wherein said step of alerting comprises one of a warning message, an audible, and an email to a location on the network remote from said security camera.

23. A computer readable medium containing software instructions that, when executed by a processor, performs the steps of:
detecting a signal from a security camera over a powerline network;
determining an operational status of said security camera based on said step of detecting;
awaiting to detect another said signal if said signal is detected; and
generating an alert if said signal is not detected.

24. The computer readable medium of claim 18, wherein said signal is sent by said video camera on a channel including video images from said security camera.

25. The computer readable medium according to claim 18, wherein said signal is sent on a carrier separate from a carrier having video images from said security camera. The computer readable medium according to claim 24, wherein said video images are contained in compressed digital video and audio signals.

26. The computer readable medium according to claim 25, wherein said video images are contained in compressed digital video and audio signals.
